(19) United States
(12) Patent Application Publication
(10) Pub. No.: US 2017/0027142 A1
(43) Pub. Date: Feb. 2, 2017

(54) TOP WATER FISHING LURE APPARATUS

(71) Applicant: Nicholas Grimaldi, Katonah, NY (US)

(72) Inventor: Nicholas Grimaldi, Katonah, NY (US)

(21) Appl. No.: 14/812,386

(22) Filed: Jul. 29, 2015

(51) Int. Cl. A01K 85/01; A01K 85/12; A01K 85/16; A01K 85/02

(52) U.S. Cl. CPC A01K 85/01; A01K 85/02; A01K 85/12; A01K 85/16

(57) ABSTRACT

A fishing lure is configured to prevent a fishing hook, or other organism capture device, from becoming entangled or caught on submerged or surface level flora by maintaining the hook above the water line while in use. Specifically, the fishing lure apparatus includes a swim body that has a curved profile that allows the swim body, when under user directed motion, to skim or ride across the surface of a body of water and maintain an attached hook in the upright position such that a barbed end of the hook is not submerged in the water.

### FIELD OF THE INVENTION

The present invention relates to a top riding fishing lure device configured to minimize the risk of hook entanglement when deployed in bodies of water containing weeds or other debris and is further configured to touch down on a body of water in the upright position and maintain that position during use.

### BACKGROUND OF THE INVENTION

The invention relates generally to fishing lures. In particular, the present invention concerns fishing lures that are controllable by the angler and designed to ride on the surface of the body of water or other fluid.

Sport fishing, in both fresh and salt water, continues to increase in popularity. Competitive and recreational fishing lures present a wide variety of mechanisms that assist the angler in catching prized fish, such as bass. In many cases, the desire to catch fish has resulted in the development of sophisticated fishing lures designed with biomimicry and other features. These lures simulate the appearance of bait and are typically more attractive to fish than simple baited hooks.

However, conventional lures exhibit several drawbacks. For example, some desired fish tend to congregate in weeded and shallow areas of ponds, lakes and the like. Only a skilled and experienced angler can consistently cast into these areas and not have their lures become entangled in weeds and other debris.

Therefore, what is needed is a fishing lure that exhibits biomimicry features to increase the chances that an aquatic organism will strike the lure. Additionally, what is also needed is a lure specifically configured to minimize the risk that the hook will become ensnared or entangled in weeds or debris.

### SUMMARY OF THE INVENTION

In broad overview, the present invention is directed to a fishing lure having a swim body. The swim body comprises a first end, a center portion, and a second end. In one particular aspect of the present invention, the center portion defines a plane and the first and second ends curve in the same direction away from this plane. Here, the first end curves a first distance away from the plane and the second end curves a second distance away from the plane and the first distance is greater than the second distance. Additionally, in a particular aspect of the present invention, the center portion has a width that is greater than the width of either the first or second ends. A hook is connected to the second end of the swim body, while a biomimicry or attraction device is connected to the first end. In the present embodiment, the hook is configured to point is the same direction as the curve of the first end and to ride out of the water when in use. Furthermore, the configuration of the swim body is such that upon touchdown on a body of water the hook is always in the upright position and does not rollover or face down when in contact with the water and maintain that position during use.

### BRIEF DESCRIPTION OF THE DRAWINGS

The foregoing and other features of the present invention will be more readily apparent from the following detailed description and drawings of illustrative embodiments of the invention in which:

FIG. 1 is a plan view of the fishing lure in a particular configuration in accordance with one embodiment of the invention;

FIG. 2 is a side view of a portion of the fishing lure of the present invention;

FIG. 3 is an alternative configuration of the fishing lure depicted in FIG. 1; and

FIG. 4 is a further side view of additional portions of the fishing lure of the present invention.

### DETAILED DESCRIPTION OF CERTAIN EMBODIMENTS OF THE INVENTION

Those possessing the requisite level of skill in the art will appreciate that the fishing lure of the present invention is suitable for catching various species of aquatic organisms, including but not limited to, various sizes and types of fresh and saltwater fish.

By way of overview and introduction, the present invention concerns a fishing lure configured to prevent a fishing hook, or other organism capture device, from becoming entangled or caught on submerged or surface level flora or debris by maintaining the hook at the water line while in use.

Specifically, the fishing lure apparatus includes a swim body that implements a curved profile that allows the swim body, when under user directed motion, to skim or ride across the surface of a body of water and maintain an attached hook in the upright position such that a barbed end does not submerge from the water.

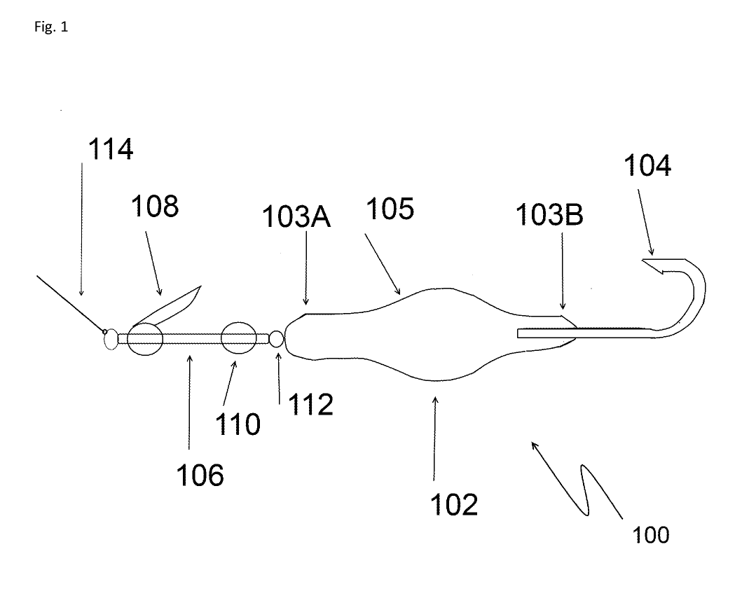

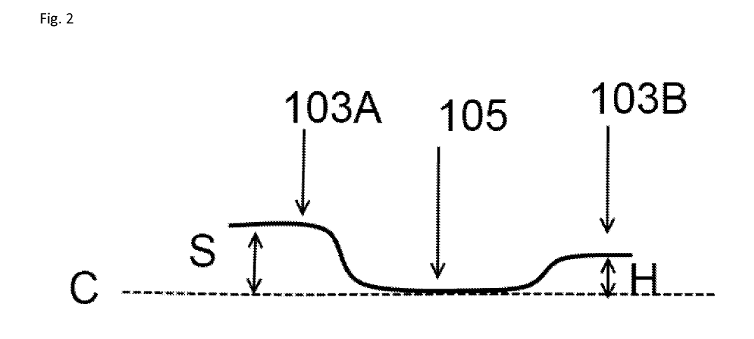

With reference to FIGS. 1 and 2, a plan view of fishing lure 100 is provided along with reference numerals addressing particular features of the invention. As shown in FIG. 1, the fishing lure 100 includes a swim body 102. The swim body 102, in a particular configuration, has a center portion 105 and end portions 103A& B. The width of the center portion 105 varies such that the width of the center portion 105 is at least as wide as the end portions 103A, 103B. In one specific configuration, the maximum width of the center portion 105 is 0.75 (3/4) inches and the minimum width is 0.375 (3/8) inches. In a further embodiment, the ratio of the width of the center portion 105 to the width of one of the end portions 103A or 103B is 1.5:0.75. In a particular arrangement of the present invention, the swim body is about 2.75 inches in length.

In one non-limiting configuration, the swim body 102 is formed from a metal material, such as brass or stainless steel. However, in alternative arrangements, the swim body 102 is formed out of composite, plastics, natural, or other materials suitable for use as a lure.

The ends 103A, 103B of the swim body 102 are rounded, or chamfered. However, in a non-limiting embodiment, the ends 103A, 103B are tapered to a point. In yet a further arrangement, the ends 103A, 103B have undulating patterns, e.g. saw-tooth or sine-wave like styled patterns.

Turning briefly to FIG. 2, a bottom surface of the center portion 105 of the swim body 102 is defined by plane C. In accordance with one aspect of the present invention, the ends 103A, 103B curve, ramp or deviate away from plane C in the same direction. In the illustrated embodiment, the ends 103A, 103B each form a lip, ridge, tab or ledge at a certain distance from the plane C. In one non-limiting embodiment, the distance that the ends 103A, 103B of the swim body 102 curve or deviate away from plane C is the same for both ends 103A, 103B. However, in an alternative arrangement, the distance S that a first end 103A curves away from the center portion 105 is different than the distance H that a second end 103B curves away from the center portion 105.

Continuing with the present example, the value for S is greater than the value for H. In an alternative embodiment, the value for S is less than the value for H. In a particular configuration, the value for S is 0.5 inches and the value of H is 0.03125 or 1/32 inches. In a further arrangement, the relationship between the value for S and the value for H can be set at 1:0.06. (S:H). Alternatively, the ratios can be inverted, or modified based on the overall dimensions, thickness, weight, or material of the swim body.

Returning to FIG. 1, a hook 104 is secured to the second end 103B of the swim body 102. While the hook 104 is depicted as a single hook, a double, triple or other hook designs can be used with the swim body 102.

In one arrangement, the hook 104 is permanently affixed, or co-extensive with the swim body. In the permanently fixed configuration, the hook 104 is secured to the second end 103B of the swim body 102 with a screw, rivet, fastener, adhesive or other article or agent used to permanently affix the hook 104 to the swim body 102.

In an alternative arrangement, the hook 104 is detachable, replaceable, removable or otherwise configurable to separate from the swim body 102. For example, the second end 103B is equipped with a socket (not shown) or other attachment device suitable for connecting a removable or replaceable hook to the swim body 102.

In a particular arrangement of elements, the hook 104 uses a worm hook configuration and is formed of metal. However, in alternative arrangements, the hook is formed out of composite, plastics, natural, or other materials suitable for use as a hook. In a further alternative arrangement, the hook 104 is a flipping hook, frog hook, drop shot hook, Carolina rig hook, bait holder hook, siwash, Aberdeen, or any other commonly known or specific fishing hook design.

In a further embodiment, a bait article is secured to the hook 104 prior to use. In one example, the bait is an organism such as a worm. However, in an alternative configuration, the bait is a simulacrum of an organism, or portion thereof. For example, a pair of frog legs, or other portion of anatomy formed of rubber or another substance can be secured to the hook 104 and used to attract the specific fish type that the user wishes to catch.

An attraction support 106 is coupled to the swim body 102 through a coupling element 112. In one example, the coupling element is a key ring, attachment loop, carabineer, or other attachment element configured to connect or secure the attraction support 106 to the swim body 102 and provide sufficient movement of the swim body relative to the attraction support 106. In the illustrated embodiment, the attraction support 106 is a metal shaft connected at one end to the swim body 102 and at the other end to a fishing line 114. In an alternative configuration, the attraction support 106 is a plastics, metal, composite material, or natural fiber wire that possesses flexible characteristics. In yet a further configuration, the attraction support 106 is a rigid body that has little flexibility. In a particular arrangement, the attraction support 106 is about 1.75 inches in length.

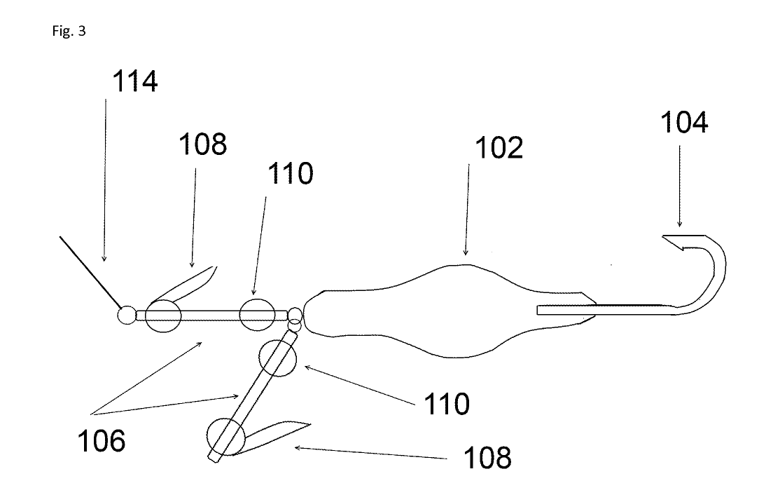

FIG. 3 details a configuration in which more than one attraction support 106 is secured to the swim body 102. In this configuration, the fishing line 114 is attached to only one of the attraction supports 106. However, in an alternative embodiment, the fishing line is connected directly to the swim body 102 and not to the attraction support 106.

In a particular configuration, a movable element 108 such as a spinner is secured to the attraction support 106. The movable element 108 is configured to rotate when passed, or moved through a fluid. For example, the movable element 108 is a propeller or rotor designed to rotate when dragged through the water. While the movable element 108 is shown to have a single spinner blade, those possessing an ordinary level of skill in the art will appreciate that other devices and mechanisms can be substituted to added to the aquatic organism attraction device to simulate or suggest movement. For example, the movable element 108 is also configurable to generate bubbles or vortices while it travels through a fluid. Likewise, the movable element is coated or formed out of a reflective or mirrored material and reflects light while moving through the water.

In one non-limiting example the movable element is a non-symmetric flange or blade configured to rotate about the attraction support 106. The rotation of this blade is designed to introduce vibrations into the fishing line and to generate disturbances within the fluid itself. Both the vibrations of the line and the disturbances of the fluid have the effect of attracting the desired aquatic organisms that the user wishes to catch.

In a further arrangement, the attraction support device 106 is equipped with adornment elements 110. The adornments are selected from decorative elements such as beads, charms or other devices and are used to attract the aquatic organisms by providing specific colors, combinations of colors, reflective properties and/or shapes. The adornment in the illustrated embodiment of FIG. 1 is secured by threading the adornment 110 on to the attraction support device 106.

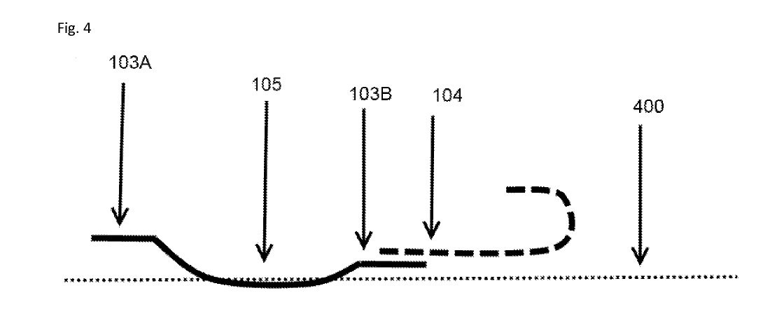

As shown in FIG. 4, the fishing lure of the present invention rides or skims along the surface of the water 400. The combination of the curved ends and bulbous center of the swim body cooperate to maintain the hook 104 in an upright position such that the hook will not catch or snag on subsurface obstacles (i.e. weeds). In operation, when a user casts the fishing lure of the present invention into a body of water, it will land (touchdown) hook up. Furthermore, as the lure moves through the water, either by the action of the user or because the user is in a vehicle, the hook will maintain an upright position and the hook will by point into the body of water.

While this specification contains the details of many specific embodiments, these should not be construed as limitations on the scope of any embodiment or of what can be claimed, but rather as descriptions of features that can be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular embodiments of the subject matter have been described in this specification. Other embodiments are within the scope of the following claims.

While the invention has been particularly shown and described with reference to preferred embodiments thereof, it will be understood by those skilled in the art that various changes in form and details may be made therein without departing from the spirit and scope of the invention.

1. A fishing lure comprising:
a. a swim body having a first end, a center portion and a second end wherein the first end and the second end curve in the same direction away from a plane defined by a bottom surface of the center portion, the first end curves a first distance away from the plane and the first distance is at least 0.5 inches, and the center portion has a varying width with a minimum width that is at least the width of either of the first or second ends; and
b. a hook connected to the second end, wherein the hook has a connected end and a barbed end, the barbed end is configured to be above the surface of a body of water upon which the swim body is placed.

2. The fishing lure of claim 1, wherein second end curves a second distance away from the plane, and first distance is greater than the second distance.

3. The fishing lure of claim 2, further comprising a fishing line removably attached to the first end of the swim body.

4. The fishing lure of claim 2, further comprising at least one attraction support device removably coupled to the first end of the swim body, the attraction support device incorporating at least one aquatic organism attraction element.

5. The fishing lure of claim 3, wherein the aquatic organism attraction element is selected from at least one of a spinner device, a bead or a reflective element.

6. The fishing lure of claim 4, wherein the ratio of the first distance to the second distance is about 1:0.06.

7. The fishing lure of claim 2, wherein the ratio of the center portion width to the first end is about 1.5:0.75.

8. The fishing lure of claim 1, wherein the connected end of the hook is removably coupled to the second end.

9. The fishing lure of claim 5, having a spinner device and wherein the spinner device is configured to generate vortices within a fluid in response to fluid flowing over the spinner device.

10. The fishing lure of claim 1, wherein upon casting into a body of water, the lure is configured to point out of the water.

11. A fishing lure comprising:
a. a swim body having a first end, a center portion and a second end, wherein the first end and the second end curve in the same direction away from a plane defined by a bottom surface of the center portion; the first end curves a first distance away from the plane, and the center portion has a varying width with a minimum width that is less than the width of either the first or second ends;
b. a hook connected to the second end wherein the hook has a connected end and a barbed end, the barbed end is located such that the barbed end is positioned above the surface of a body of water over which the swim body is drawn;
c. an organism attraction apparatus coupled to the first end, the organism attraction apparatus having at least one device that rotates about the organism attraction device in response to movement of the swim body through a fluid.
